(19) United States
(12) Patent Application Publication
(10) Pub. No.: US 2019/0073086 A1
(43) Pub. Date: Mar. 7, 2019

(54) ELECTRONIC APPARATUS AND CONTROL METHOD THEREOF

(71) Applicant: CANON KABUSHIKI KAISHA, Tokyo (JP)

(72) Inventor: Satoshi Ishimaru, Kawasaki-shi (JP)

(21) Appl. No.: 16/115,841

(22) Filed: Aug. 29, 2018

(30) Foreign Application Priority Data
Sep. 1, 2017 (JP) 2017-168480

(51) Int. Cl. G06F 3/041; G06F 3/044; H04N 5/225; G06F 1/16

(52) U.S. Cl. CPC G06F 3/0418; G06F 3/044; H04N 5/2252; H04N 5/232933; G06F 1/1601; G06F 1/1677; H04N 5/22525

(57) ABSTRACT

An electronic apparatus includes: a signal generator configured to output a signal which indicates a position of a monitor relative to a casing; and a memory and at least one processor which function as a control unit configured to: control a display to a non-display state, when the signal changes from an open signal, which indicates an open position in which the monitor is opened relative to the casing, to a close signal, which indicates a close position in which the monitor is closed relative to the casing so that a display surface of the display faces the casing, and then a first period elapses without acquiring the open signal; and implement control of disabling the touch operation to the display surface without waiting for the elapse of the first period, when the signal changes from the open signal to the close signal.

### BACKGROUND OF THE INVENTION

### Field of the Invention

The present invention relates to an electronic apparatus and a control method thereof.

### Description of the Related Art

A structure of a display operation panel that is openable relative to an apparatus main body is known, and in this structure, a touch panel display, which is a touch panel disposed on a display surface of a display panel (hereafter called “display operation panel”), is connected to the apparatus main body via a hinge mechanism. This structure is used for many electronic apparatuses, including a digital camera, a digital video camera, a game machine and a mobile terminal. The display operation panel is used in a plurality of states, such as a state when the display operation panel is closed such that the display surface contacts the apparatus main body (close state), and a state when the display operation panel is separated from the apparatus main body so that the display surface is visible (open state). A known configuration in such an electronic apparatus is that a sensor, to detect whether the display operation panel is in a closed state or an opened state, is disposed, and the operation of the display operation panel is switched, depending on whether the display operation panel is in close state or open state.

Japanese Patent Application Publication No. 2012-019279 discloses a camera having a structure in which a liquid crystal display panel is openably connected to the camera main body by a biaxial hinge mechanism. According to a technique in Japanese Patent Application Publication No. 2012-019279, a magnet is disposed at a movable portion, and a Hall element is disposed at a corresponding position on the camera main body side, so that the opening/closing of a liquid crystal display panel is detected by the output of the Hall element.

### SUMMARY OF THE INVENTION

A capacitance type touch panel is frequently used for a display operation panel of an electronic apparatus, due to such an advantage as multi-touch possibilities. For a material of a casing (outer package) of an electronic apparatus, on the other hand, a conductive material such as carbon may be used due to the advantages of functionality (e.g. electrostatic countermeasure) and design.

However, in the case of the above mentioned electronic apparatus having the openable structure, combining a capacitance type touch panel with an apparatus main body formed of a conductive material has been avoided. This is because when the touch panel approaches the apparatus main body to close the display operation panel, the capacitance of the touch panel changes, and this may be erroneously detected as touch input. In other words, a touch input, unintended by the user, may be generated before the display operation panel is completely closed (during transition from open state to close state), whereby the electronic apparatus may malfunction.

With the foregoing in view, it is an object of the present invention to provide a technique to prevent the erroneous detection of touch input during the transition from the open state to the close state.

A first aspect of the present invention provides an electronic apparatus, comprising: a casing; a monitor configured to be openable relative to the casing, the monitor including a display and a capacitance type touch detector which detects touch operation to a display surface of the display; a signal generator configured to output a signal which indicates a position of the monitor relative to the casing; and a memory and at least one processor which function as a control unit configured to: control the display to a non-display state, when the signal output from the signal generator changes from an open signal, which indicates an open position in which the monitor is opened relative to the casing, to a close signal, which indicates a close position in which the monitor is closed relative to the casing so that the display surface faces the casing, and then a first period elapses without acquiring the open signal; and implement control of disabling the touch operation to the display surface without waiting for the elapse of the first period, when the signal output from the signal generator changes from the open signal to the close signal.

According to the present invention, erroneous detection of touch input during the transition from the open state to the close state can be prevented.

Further features of the present invention will become apparent from the following description of exemplary embodiments with reference to the attached drawings.

### BRIEF DESCRIPTION OF THE DRAWINGS

FIG. 1A and FIG. 1B are perspective views depicting an appearance of a digital video camera according to Example 1;

FIG. 2 is a block diagram depicting an internal configuration of the digital video camera according to Example 1;

FIG. 3 is a diagram depicting a control during transition from the open state to the close state according to Example 1;

FIG. 4 is a flow chart depicting a control during transition from the open state to the close state according to Example 1;

FIG. 5 is a diagram depicting a control during transition from the close state to the open state according to Example 1;

FIG. 6 is a flow chart depicting during transition from the close state to the open state according to Example 1;

FIG. 7A and FIG. 7B are examples of a display screen of a digital video camera according to Example 2; and

FIG. 8 is a flow chart depicting a control according to Example 2.

### DESCRIPTION OF THE EMBODIMENTS

Embodiments of the present invention will be described with reference to the drawings. The present invention relates to an electronic apparatus having a display operation panel (touch panel display) configured to be openable relative to an apparatus main body (main body, casing), and more particularly as a control to prevent erroneous detection of touch input when the display operation panel is opened/closed. In the following, a case of applying the technique according to the present invention to a digital video camera will be described. However, the configuration and the application range of the present invention are not limited to the following examples, and the present invention can be appropriately applied to any type of apparatus if the apparatus is an electronic apparatus with a display operation panel having an openable structure.

### Example 1

### Configuration of Electronic Apparatus

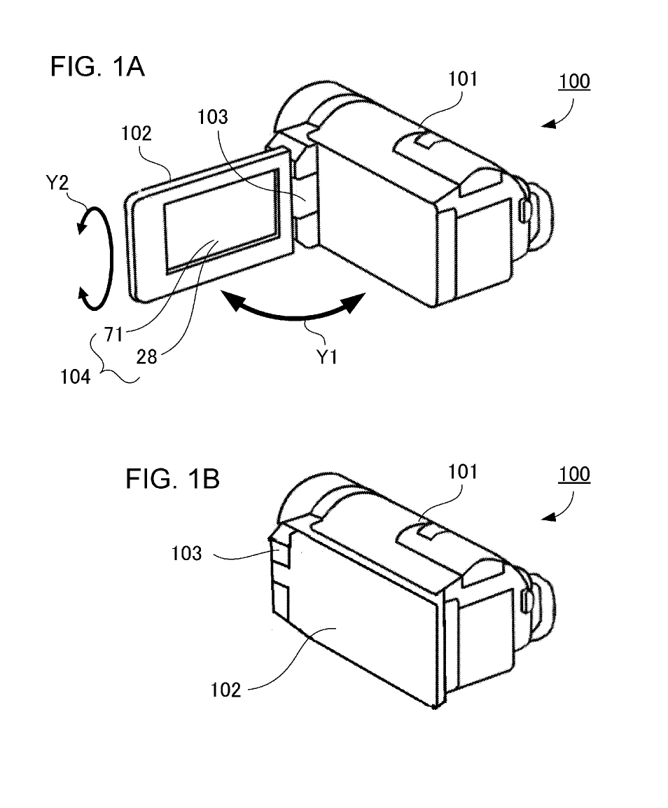

FIG. 1A and FIG. 1B are perspective views depicting an appearance of a digital video camera 100 according to Example 1. The digital video camera 100 has a main body 101 and a vari-angle monitor 102. A display operation panel 104 is disposed in the vari-angle monitor 102. The display operation panel 104 is constituted by a display 28 and a touch panel 71 disposed on the display surface of the display 28. The display 28 is a display device constituted by an LCD (liquid display) or an OLED (organic EL display), for example, and the touch panel 71 is a capacitance type touch sensor (touch detector).

The vari-angle monitor 102 is connected to the main body 101 by a biaxial hinge mechanism 103, and has a structure in which opening/closing in the arrow Y1 direction and rotation in the arrow Y2 direction are possible. Because of this structure, the vari-angle monitor 102 can be used in various states in accordance with the scene used by the user. For example, in FIG. 1A, the vari-angle monitor 102 is opened from the main body 101, so that the display surface of the display 28 can be seen. In this description, the state in FIG. 1A is called the “open state”, and the position of the vari-angle monitor 102 in FIG. 1A is called the “open position”. For example, in the case of shooting images while viewing the live view image on the display 28, or in the case of playing back the captured image on the display 28, the open state is preferable. In FIG. 1B, the vari-angle monitor 102 is closed so that the display surface of the display 28 faces the main body 101. In this description, the state in FIG. 1B is called the “close state”, and the position of the vari-angle monitor 102 in FIG. 1B is called the “close position”. For example, in the case of shooting images while viewing a finder, the close state is preferable.

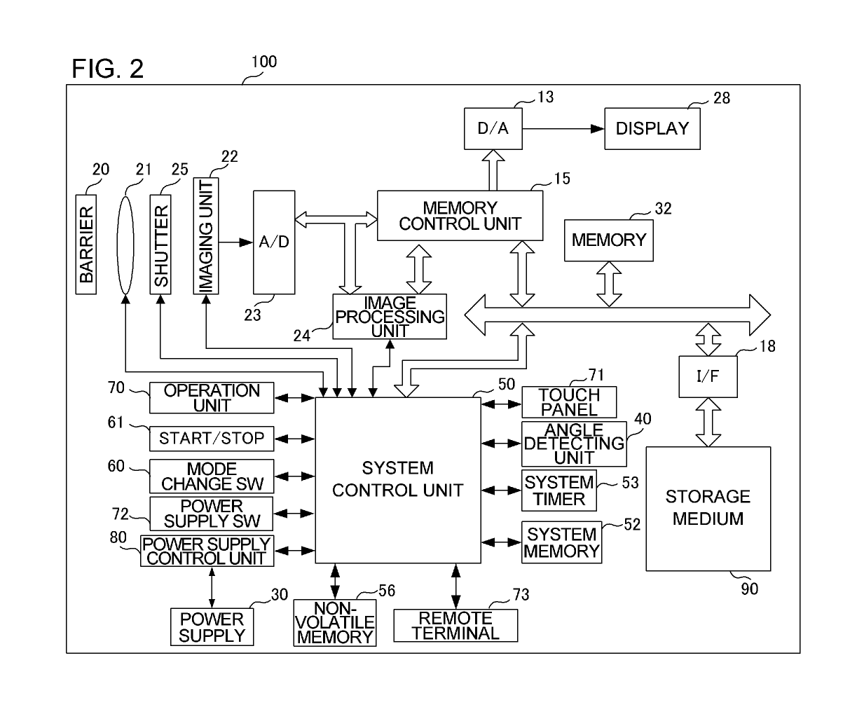

FIG. 2 is a block diagram depicting the internal configuration of the digital video camera 100. In FIG. 2, an imaging lens 21 is a lens group, including a zoom lens and focus lens. The shutter 25 is a shutter which has a diaphragm function. An imaging unit 22 is an imaging element constituted by a CCD or CMOS, which converts an optical image into an electric signal. An A/D converter 23 converts an analog signal into a digital signal. The A/D converter 23 is used to convert an analog signal, which his output from the imaging unit 22, into a digital signal. A barrier 20 covers the imaging system (imaging lens 21, shutter 25, imaging unit 22 and the like), so as to prevent contamination of and damage to the imaging system.

An image processing unit 24 performs resize processing and color conversion processing, such as predetermined pixel interpolation and reduction, on data from the A/D converter 23 or data from a memory control unit 15. Further, the image processing unit 24 performs a predetermined arithmetic processing using the captured image data, and a system control unit 50 performs exposure control and distance measuring control based on the acquired computed result. Thereby TTL (Through The Lens) type AF (Auto Focus) processing, AE (Automatic Exposure) processing and EF (Electronic Flash pre-emission) processing are performed. Furthermore, the image processing unit 24 also performs predetermined arithmetic processing using captured image data, and also performs TTL type AWB (Auto White Balance) processing based on the acquired computed result.

The output data from the A/D converter 23 is written to a memory 32 via the image processing unit 24 and the memory control unit 15, or is directly written to the memory 32 via the memory control unit 15. The memory 32 stores: the image data which is acquired by the imaging unit 22 and is converted into digital data by the A/D converter 23; and the image data to be displayed on the display surface of the display 28. The memory 32 has sufficient storage capacity to store a predetermined number of still images and a predetermined time of moving images and sound.

The memory 32 also functions as a memory (video memory) for displaying images. A D/A converter 13 converts the data for displaying images stored in the memory 32 into an analog signal, and supplies the analog signal to the display 28. In this way, the image data for display, written to the memory 32, is displayed on the display surface of the display 28 via the D/A converter 13. The display 28 performs display in accordance with the analog signal from the D/A converter 13. By converting the digital signal, which was converted from an analog signal by the A/D converter 23 and stored in the memory 32, into the analog signal again by the D/A converter 13, and sequentially transferring the analog signals to the display 28 and displaying in accordance with the analog signals on the display surface of the display 28, the display 28 can perform a through-image display (live-view display).

A non-volatile memory 56 is a memory that can be electrically erased and recorded, and an EEPROM, for example, can be used. The non-volatile memory 56 stores constants to operate a system control unit 50 and programs. The programs here refer to the programs that execute various flow charts described later in Example 1.

The system control unit 50 controls the digital video camera 100 in general. The system control unit 50 is constituted by a CPU (processor), for example. A system memory 52 is a RAM, which is used as a work memory, where the constants and variables for operating the system control unit 50, and the programs read from the non-volatile memory 56 and the like are developed. The system control unit 50 develops a program recorded in the non-volatile memory 56 in the system memory 52, and executes this program, whereby each processing of the digital video camera 100, described later, is implemented. The system control unit 50 also controls display by controlling the memory 32, the D/A converter 13, the display 28 and the like. A system timer 53 is a timer that measures the time used for various controls, and the time of the internal clock.

A mode change switch 60, a START/STOP switch 61 and an operation unit 70 are operation units to input various operation instructions to the system control unit 50.

The mode change switch 60 switches the operation modes of the system control unit 50 to one of: a still image recording mode, a moving image recording mode, a playback mode and the like. The modes included in the still image recording mode are: auto imaging mode, auto scene determining mode, manual mode, various scene modes to set imaging depending on the imaging scene, program AE mode, custom mode and the like. The mode change switch 60 can directly switch (from the currently set mode) to one of these modes included in the still image recording mode. Alternatively, after switching to the still image recording mode by the mode change switch 60, another operation member may be allowed to switch the mode to one of these modes included in the still image recording mode. In the same manner, a plurality of modes may be included in the moving image recording mode.

The START/STOP switch 61 is a switch to start/stop the recording of a moving image if the system is in the moving image recording mode, and a switch to start/stop a still image if the system is in the still image recording mode. If pressing the START/STOP switch 61 is detected, the system control unit 50 starts operation of a series of imaging processing operations, from reading the signal from the imaging unit to writing the image data to the recording medium 90.

An operation unit 70 includes a plurality of operating members (e.g. button, dial). By selecting one of the various functional icons displayed on the display 28, a corresponding function is assigned to each screen, and these operating members operate as various functional buttons. The functional buttons are, for example, an end button, a return button, an image feed button, a jump button, a narrow down button, an attribute change button and the like. For example, if a menu button is pressed, various menu screens that can be set are displayed on the display surface of the display 28. The user can intuitively perform various settings using: the menu screen displayed on the display surface of the display 28, the four direction buttons (up, down, left, right) and the SET button. As an operating member of the operation unit 70, a display change button is included to change the display/non-display of the operation buttons which are operated via the touch panel 71. By pressing the display change button, the display/non-display of the operation buttons can be switched.

Besides the operation unit 70, the digital video camera 100 has the touch panel 71 as an input unit, which can detect the contact to the display surface of the display 28. The touch panel 71 is attached to the display surface of the display 28, where the input coordinates on the touch panel 71 are corresponded to the display coordinates on the display surface of the display 28 in advance. Thereby a GUI, which allows the user to directly operate on the screen displayed on the display 28, can be constructed.

The system control unit 50 can detect the following touch operations to the touch panel 71, or the state thereof

A finger or a pen, which previously did not touch the touch panel 71, is touching the touch panel 71. In other words, touching started (hereafter called “Touch-Down”).

A finger or a pen is touching the touch panel 71 (hereafter called “Touch-On”).

A finger or a pen is moving in the state of touching the touch panel 71 (hereafter called “Touch-Move”).

A finger or a pen, that is touching the touch panel 71, is released. In other words, touching ended (hereafter called “Touch-Up”).

Nothing is touching the touch panel 71 (hereafter called “Touch-Off”).

When Touch-Down is detected, Touch-On is also detected at the same time.

Normally Touch-On is detected continuously after Touch-Down, unless Touch-Up is detected. The detection of Touch-Move is also in the state of Touch-On. Touch-Move is not detected even if Touch-On is detected, if the touch position does not move. After Touch-Up is detected for all the fingers or the pen touching the touch panel, Touch-Off is detected.

These operations, states and coordinates of the position on the touch panel 71, where a finger or a pen is touching, are notified to the system control unit 50 via an internal bus. Based on the information that is notified, the system control unit 50 determines the kind of operation (touch operation) performed on the touch panel 71. In the case of Touch-Move, the moving direction of the finger or the pen moving on the touch panel 71 is also determined for the vertical component and the horizontal component on the touch panel 71 respectively based on the change in the coordinates of the position. If Touch-Move is detected for a predetermined distance or more, the system control unit 50 determines that a slide operation was performed. An operation of quickly moving a finger touching the touch panel 71 for a short distance and releasing the finger is called a “flick”. In other words, flick is an operation of quickly touching the touch panel 71 and releasing the finger. If Touch-Move at a predetermined or higher speed for a predetermined or longer distance, and Touch-Up is detected thereafter, then the state is determined as a flick (it is determined that a flick was performed after the slide operation). An operation of simultaneously touching a plurality of locations (e.g. two points) then bringing these touching positions closer to each other is called a “pinch-in”, and an operation of moving these touching positions away from each other is called a “pinch-out”. Pinch-in and pinch out are collectively called a “pinch operation” (or simply a “pinch”).

A remote terminal 73 is a terminal which enables control from an external apparatus. The system control unit 50 can control the digital video camera 100 by receiving a command from an external apparatus. For example, when a command to switch the display/non-display of the operation buttons is received from the remote terminal 73, the system control unit 50 performs control to switch the display and non-display of the operation buttons.

An angle detecting unit 40 is a signal output unit (a signal generator, an angle detector, an angle sensor) which is disposed in the biaxial hinge mechanism 103 to support the vari-angle monitor 102, and generates and outputs a signal to indicate a position (opening degree) of the vari-angle monitor 102, with respect to the main body 101. In Example 1, the angle detecting unit 40 is constituted by a physical switch which becomes a pressed state when the vari-angle monitor 102 is in the open position, as illustrated in FIG. 1A, and is in the released state when the vari-angle monitor 102 is in the close position, as illustrated in FIG. 1B. By the output signal of the angle detecting unit 40 (output signal of the switch), it can be determined whether the vari-angle monitor 102 is in an open or close state. For the angle detecting unit 40, another type of switch, such as an optical switch, may be used.

A power supply control unit 80 is constituted by a battery detecting circuit, a DC-DC converter, a switch circuit to change the block to which power is supplied and the like. The power supply control unit 80 detects whether a battery is installed, the type of battery, and the residual capacity of a battery. Further, the power supply control unit 80 controls the DC-DC converter based on the detection result and the instruction from the system control unit 50, and supplies necessary voltage to each unit, including a recording medium 90 during a necessary period. Further, the power supply control unit 80 includes a charging circuit, and supplies power to a power supply unit 30 based on the instruction from the system control unit 50, and charges the battery. The power supply unit 30 is constituted by a battery, an AC adapter and the like. A recording medium OF 18 is an interface with the recording medium 90. The recording medium 90 is a recording medium to store the captured image data, and is constituted by a semiconductor memory, a magnetic disk or the like.

The casing (outer package) of the main body 101 of the digital video camera 100 is made of a conductive material (e.g. a material containing carbon). By covering the main body 101 by a material having conductivity, electrostatic countermeasures can be implemented.

When the casing is formed of a conductive material, as in Example 1, the following problem may occur. That is, when the side face of the casing of the main body 101 (surface facing the display surface in the close state) approaches the touch panel 71 while moving the vari-angle monitor 102 from the open position to the close position, electrostatic capacitance changes, and this may be erroneously detected as a touch input. This detected touch input is unintended by the user, and may cause a malfunction of the digital video camera 100.

Control During Transition from Open State to Close State

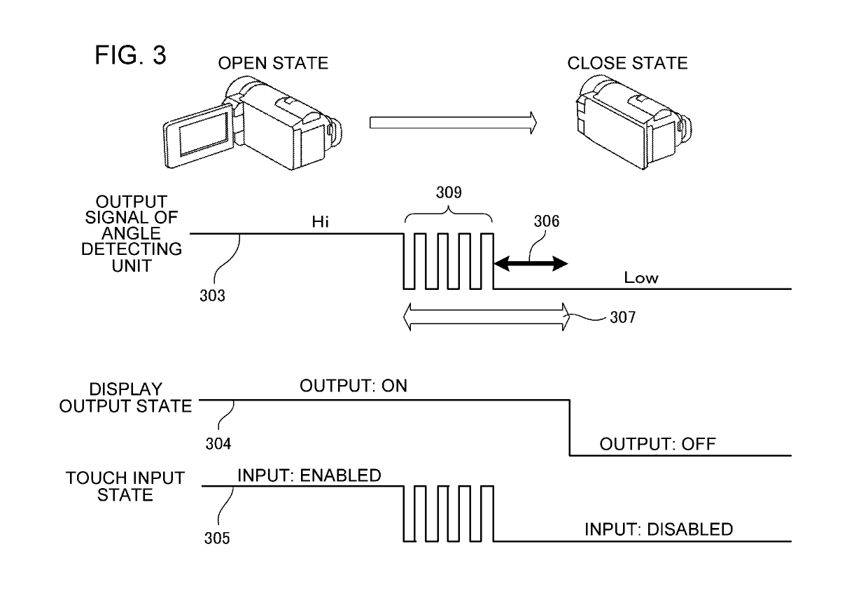

FIG. 3 is a schematic diagram depicting: the timing of the display/non-display control of the display 28; and the enable/disable control of the touch operation of the touch panel 71 during transition of the vari-angle monitor 102 of the digital video camera 100 from the open state to the close state.

The reference number 303 indicates the change of a signal (that is, a state of the switch) output from the angle detecting unit 40 when the vari-angle monitor 102 changed from the open state to the close state. When the vari-angle monitor 102 is in the open position, the output signal becomes a signal at Hi level (open signal), and when the vari-angle monitor 102 is in the close position, the output signal becomes a signal at Low level (close signal). Since the angle detecting unit 40 of Example 1 is a switch, chatter, indicated by the reference number 309, is generated in the transition from the open state to the close state.

The reference number 304 indicates a change in the ON/OFF state of the output of the display 28. The system control unit 50 controls the display output to ON if the output signal of the angle detecting unit 40 is Hi, and controls the display output to OFF if the output signal is Low. Since the chatter 309 is generated during the transition from the open state to the close state, the system control unit 50 does not control the display output to OFF immediately after the output signal changes from Hi to Low, but switches the display output to OFF after at least a first period 306 elapses in the Low state. By this control, the display output remains ON during the period 307 indicated by the white arrow. This period 307 is the period during which chatter is eliminated (chatter countermeasure period). Setting the chatter eliminating period 307 is to prevent a drop in the display quality caused by the quick switching of ON/OFF of the display output due to the influence of chatter in the switch.

The reference number 305 indicates the change of enable/disable of the touch input to the touch panel 71. The system control unit 50 enables touch input if the output signal of the angle detecting unit 40 is Hi, and disables touch input if the output signal is Low. In the case of the control of enable/disable of the touch input, the chatter eliminating period is not set. In other words, when the output signal changes from Hi to Low, the system control unit 50 immediately disables the touch input without waiting for the elapse of the first period 306. Therefore, even if the touch panel 71 approaches the conductive casing of the main body 101 during transition from the open state to the close state, the generation of erroneous detection of touch input can be prevented since the touch input is disabled.

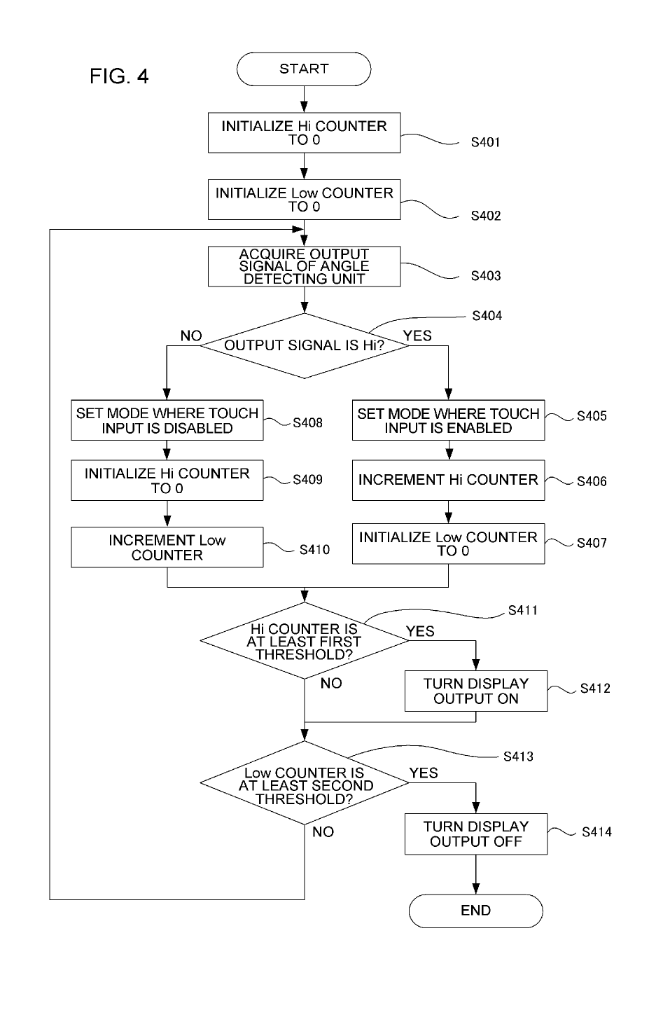

FIG. 4 is a flow chart depicting the display/non-display control of the display 28, and the enable/disable control of the touch operation to the touch panel 71 when the vari-angle monitor 102 of the digital video camera 100 is changed from the open state to the close state. The processing in FIG. 4 is started when the display 28 of the digital video camera 100 is in the display state, and the touch operation to the touch panel 71 is enabled.

In step S401, the system control unit 50 initializes a Hi counter (open signal counter), which manages the ON control of the output of the display 28, to 0. When this processing completes, processing advances to step S402. In step S402, the system control unit 50 initializes a Low counter (close counter), which manages the OFF control of the output of the display 28, to 0. When this processing completes, processing advances to step S403.

In step S403, the system control unit 50 acquires a signal that is output from the angle detecting unit 40. When this processing completes, processing advances to step S404. In step S404, the system control unit 50 determines whether the output signal acquired in step S403 is Hi or Low.

If the output signal is Hi, the system control unit 50 determines that the vari-angle monitor 102 is in the open state, and processing advances to step S405. In step S405, the system control unit 50 sets the mode to enable touch input, and if touch input is received, the system control unit 50 performs the processing in accordance with the touch input. When this processing completes, processing advances to step S406. In step S406, the system control unit 50 increments the Hi counter. In step S407, the system control unit 50 initializes the Low counter to 0. When this processing completes, processing advances to step S411.

If the output signal is Low, processing advances to step S408. In step S408, the system control unit 50 sets the mode to disable touch input, so that even if touch input is received, the touch input is disabled, and no processing is performed. When this processing completes, processing advances to step S409. In step S409, the system control unit 50 initializes the Hi counter to 0. When this processing completes, processing advances to step S410. In step S410, the system control unit 50 increments the Low counter. When this processing completes, processing advances to step S411.

In step S411, the system control unit 50 determines whether the Hi counter is at least a first threshold Th1. For example, if it is assumed that the acquisition of the output signal in step S403 is executed every time when time t elapses, the Hi counter, indicating at least the first threshold Th1, indicates that the output signal is in the Hi state for at least time (Th1×t). Therefore, if the Hi counter indicates at least the first threshold, the system control unit 50 determines that the switch is not in the chatter state, and the vari-angle monitor 102 is in the open state and is stable. In step S412, the system control unit 50 controls the display 28, and turns the output of the display 28 ON. When this processing completes, processing advances to step S413.

In step S413, the system control unit 50 determines whether the Low counter is at least a second threshold Th2. For example, if it is assumed that the acquisition of the output signal in step S403 is executed every time when time t elapses, the Low counter, indicating at least the second threshold Th2, means that the output signal is in the Low state for at least time (Th2×t). Therefore, if the Low counter indicates at least the second threshold, the system control unit 50 determines that the switch is not in the chatter state, and the vari-angle monitor 102 is in the close state, and is stable. In step S414, the system control unit 50 controls the display 28, and turns the output of the display 28 OFF. When this processing completes, processing ends.

Control During Transition from Close State to Open State

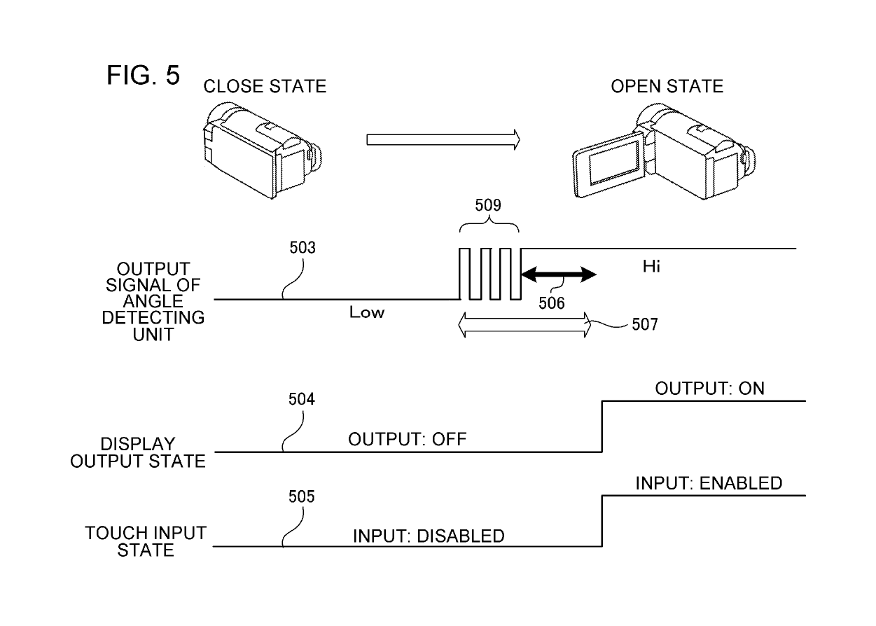

FIG. 5 is a schematic diagram depicting the timing of the display/non-display control of the display 28, and enable/disable control of the touch operation to the touch panel 71, during transition of the vari-angle monitor 102 of the digital video camera 100 from the close state to the open state.

The reference number 503 indicates the change of a signal (that is, a state of the switch) output from the angle detecting unit 40 when the vari-angle monitor 102 changed form the close state to the open state. When the vari-angle monitor 102 is in the close position, the output signal becomes Low level, and when the vari-angle monitor 102 is in the open position, the output signal becomes Hi level. Since the angle detecting unit 40 of Example 1 is a switch, chatter, indicated by the reference number 509, is generated in the transition from the close state to the open state.

The reference number 504 indicates a change of the ON/OFF state of the output of the display 28. The system control unit 50 controls the display output to ON if the output signal of the angle detecting unit 40 is Hi, and controls the display output to OFF if the output signal is Low. Since the chatter 509 is generated during the transition from the close state to the open state, the system control unit 50 does not control the display output to ON immediately after the output signal changes from Low to Hi, but switches the display output to ON after at least a second period 506 elapses in the Hi state. By this control, the display output remains OFF during the period 507 indicated by the white arrow. This period 507 is the chatter eliminating period (chatter countermeasure period). Setting the chatter eliminating period 507 is to prevent a drop in the display quality caused by the quick switching of ON/OFF of the display output due to the influence of chatter in the switch.

The reference number 505 indicates the change of enable/disable of the touch input to the touch panel 71. The system control unit 50 switches enable/disable of the touch input to the touch panel 71 in accordance with the switching of ON/OFF of the display 28. In other words, the system control unit 50 enables touch input after at least the second period 506 elapses in the Hi state of the output signal. When the vari-angle monitor 102 is opened, erroneous detection of touch input, due to the approach of the touch panel 71 and the casing, is not generated, hence the timing of switching of the display/non-display of the display 28 and the timing of switching of enable/disable of the touch operation are synchronized.

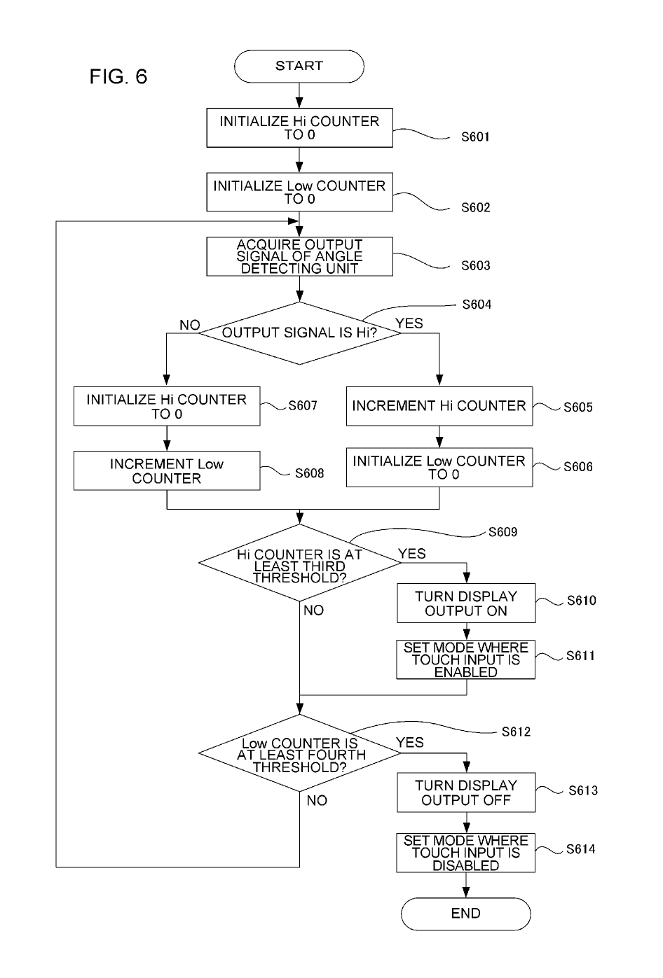

FIG. 6 is a flow chart depicting the display/non-display control of the display 28 and the enable/disable control of the touch operation to the touch panel 71 when the vari-angle monitor 102 of the digital video camera 100 is moved from the open state to the close state. The processing in FIG. 6 is started when the display 28 of the digital video camera 100 is in the non-display state, and the touch operation to the touch panel 71 is disabled.

In step S601, the system control unit 50 initializes the Hi counter (open signal counter), which manages the ON control of the output of the display 28 and enabling of the touch input, to 0. When this processing completes, processing advances to step S602. In step S602, the system control unit 50 initializes the Low counter (close signal counter), which manages the OFF control of the output of the display 28 and disabling of the touch input, to 0. When this processing completes, processing advances to step S603.

In step S603, the system control unit 50 acquires a signal that is output from the angle detecting unit 40. When this processing completes, processing advances to step S604. In step S604, the system control unit 50 determines whether the output signal acquired in step S603 is Hi or Low.

If the output signal is Hi, the system control unit 50 determines that the vari-angle monitor 102 is in the open state, and processing advances to step S605. In step S605, the system control unit 50 increments the Hi counter. In step S606, the system control unit 50 initializes the Low counter to 0. When this processing completes, processing advances to step S609.

If the output signal is Low, processing advances to step S607. In step S607, the system control unit 50 initializes the Hi counter to 0. In step S608, the system control unit 50 increments the Low counter. When this processing completes, processing advances to S609.

In step S609, the system control unit 50 determines whether the Hi counter is at least a third threshold Th3. For example, if it is assumed that the acquisition of the output signal in step S603 is executed every time when time t elapses, the Hi counter, indicating at least the third threshold Th3, means that the output signal is in the Hi state for at least time (Th 3×t). Therefore, if the Hi counter is at least the third threshold, the system control unit 50 determines that the switch is not in the chatter state, and the vari-angle monitor 102 is in the open state, and is stable. In step S610, the system control unit 50 controls the display 28, and turns the output of the display 28 ON. Further, in step S611, the system control unit 50 sets a mode in which the touch input is enabled, and performs processing in accordance with the touch input if touch input is received. When this processing completes, processing advances to step S612.

In step S612, the system control unit 50 determines whether the Low center is at least a fourth threshold Th4. For example, if it is assumed that the acquisition of the output signal in step S603 is executed every time when time t elapses, the Low counter, indicating at least the fourth threshold Th4, means that the output signal is in the Low state for at least time (Th4×t). Therefore, if the Low counter is at least the fourth threshold, the system control unit 50 determines that the switch is not in the chatter state, and the vari-angle monitor 102 is in the close state, and is stable. In step S613, the system control unit 50 controls the display 28, and turns the output of the display 28 OFF. Further, in step S614, the system control unit 50 sets a mode in which the touch input is disabled, and controls so that the touch input is disabled and processing is not performed even when a touch input is received. When this processing completes, processing ends.

### Advantages of Example 1

As described above, if the output signal of the angle detecting unit 40 changes from Hi (open signal) to Low (close signal) when the vari-angle monitor 102 changes from the open state to the close state, the touch operation is immediately disabled. Therefore, even if the touch panel 71 approaches the casing (or other conductive member) of the main body 101, erroneous detection of the touch input and malfunction of the apparatus thereby do not occur. Further, the output of the display 28 is switched to the non-display state if the output signal changes from Hi to Low and a predetermined time elapses thereafter without changing to Hi. Hence a drop in the display quality due to chatter can be prevented. Each value of the first threshold to the fourth threshold used in Example 1 may be set to an arbitrary value, or all may be set to the same value, or may be set to different values.

### Example 2

Example 2 of the present invention will be described next. In Example 1, the enable/disable control of the touch operation is changed between the transition from the open state to the closed state (FIG. 3, FIG. 4) and the transition from the close state to the open state (FIG. 5, FIG. 6). In Example 2, on the other hand, the enable/disable control of the touch operation is changed, depending on whether the screen displayed on the display 28 is a first screen in which functions corresponding to the start of touching (Touch-Down) can be executed, or a second screen in which functions corresponding to the start of touching cannot be executed. For example, when the first screen, in which functions corresponding to the start of touching can be executed, is displayed on the display 28, the touch operation may be immediately disabled if the Low signal (close signal) is detected, so as to prevent erroneous detection of touch input. On the other hand, when the second screen, in which functions corresponding to the start of touching cannot be executed, is displayed on the display 28, the chatter eliminating period may be set so that ON/OFF of the display 28 and enable/disable of the touch operation are switched at a same timing.

Display Screen Example

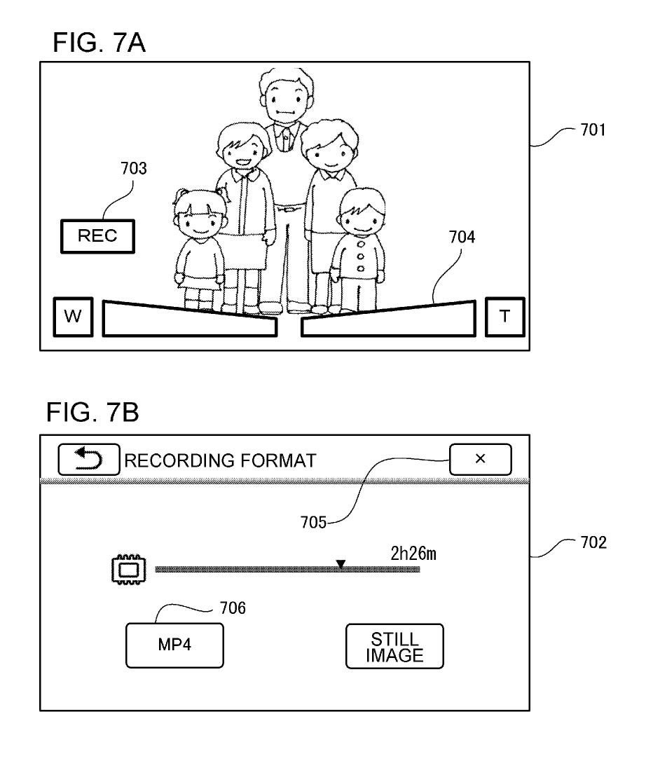

FIG. 7A and FIG. 7B are examples of screens displayed on the display 28 of the digital video camera 100.

The screen 701 in FIG. 7A is a screen displayed in shooting mode of the digital video camera 100, and includes touch buttons (an REC button 703 to start or end moving video image recording, and a Zoom button 704 to perform zoom operation). The system control unit 50 performs the moving image recording control if Touch-Down of the REC button 703 is detected, and performs zoom control if Touch-Down of the Zoom button 704 is detected. The screen 701 is an example of the first screen, in which functions corresponding to the start of the touching can be executed.

The screen 702 in FIG. 7B is one of the menu setting screens of the digital video camera 100, and is a screen to select a recording format. The screen 702 includes touch buttons of a Close button 705 to close the screen, an MP4 Set Value button which is one of the recording set values and the like. The system control unit 50 performs a control to close the screen if the Touch-Up of the Close button 705 is detected, and sets MP4 as the set value of the recording format if Touch-Up of the MP4 Set value button is detected. The screen 702 is an example of the second screen in which functions corresponding to the start of touching cannot be not executed.

Display Output and Touch Operation Control

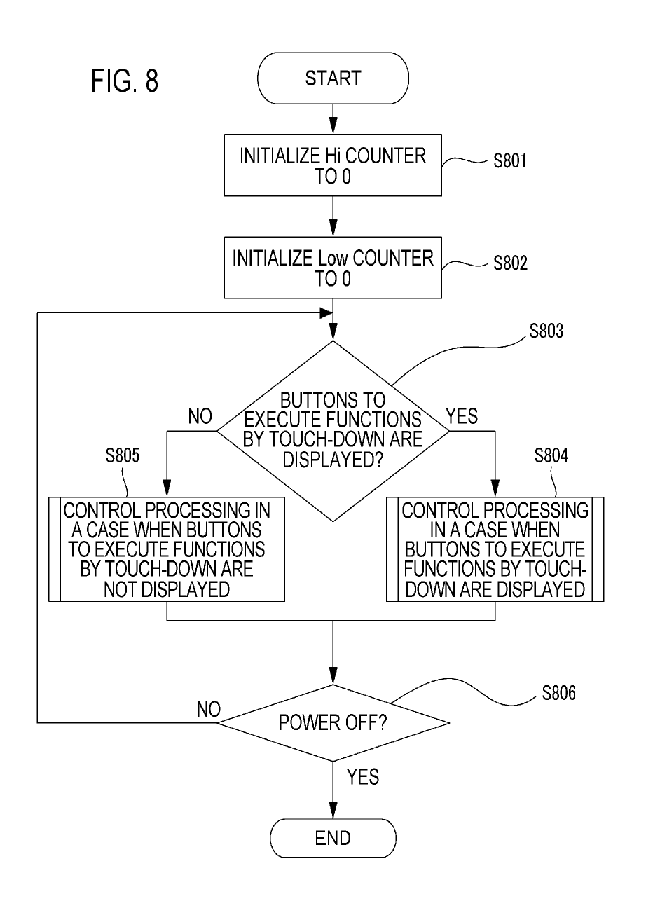

FIG. 8 is a flow chart depicting the display/non-display control of the display 28 and the enable/disable control of the touch operation to the touch panel 71 in accordance with the screen displayed on the display 28 of the digital video camera 100.

In step S801, the system control unit 50 initializes a Hi counter to 0. When this processing completes, processing advances to step S802. In step S802, the system control unit 50 initializes the Low counter to 0. When this processing completes, processing advances to step S803.

In step S803, the system control unit 50 determines whether the touch buttons, to execute the functions by the Touch-Down operation, are displayed on the screen of the display 28. If it is determined that the touch buttons are displayed, processing advances to step S804. If it is determined that the touch buttons are not displayed, processing advances to step S805.

In step S804, the same processing as steps S403 to S414 in FIG. 4 are executed. In step S805, the same processing as steps S603 to S614 in FIG. 6 are executed. When this processing completes, processing advances to step S806.

In step S806, the system control unit 50 determines whether the power supply switch 72 is operated to shut the power OFF. If it is determined that power is shut OFF, processing ends. If it is determined that power is not shut OFF, processing advances to step S803.

### Advantages of Example 2

As described above, if the output signal of the angle detecting unit 40 changes from Hi (open signal) to Low (close signal) when the buttons to execute the functions by the Touch-Down operation are displayed on the screen, the touch operation is immediately disabled. Therefore, even if the touch panel 71 approaches the casing (or other conductive members) of the main body 101, erroneous detection of the touch input and malfunction of the apparatus thereby do not occur.

Other

In the above description, the various above mentioned controls are performed by the system control unit 50, but may be performed by one hardware component, or may be shared by a plurality of hardware components (e.g. a plurality of processors or circuits), so as to control the entire apparatus.

Embodiments of the present invention were described above, but the present invention is not limited to these specific examples, but include various forms within the scope of not departing from the essence of the present invention. Each example described above is merely an embodiment of the present invention, and may be appropriately combined.

In the description of the above examples, the present invention is applied to a digital video camera, but the present invention is not limited to this example, but is applicable to any electronic apparatus which has a display operation panel that is openable relative to the apparatus main body. In other words, the present invention may be applied to a notebook PC, PDA, portable telephone terminal, smartphone, tablet, portable image viewer, printer with a display, digital photo frame, music player, game machine, electronic book reader and the like.

The present invention may be implemented by executing the following. That is, a software (program), to implement the functions of the above mentioned examples, is supplied to a system or an apparatus via a network or various storage media, and the computer (or CPU or MPU) of this system or apparatus reads and executes the program codes. In this case, the programs and the storage medium storing this program are regarded as a part of the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-168480, filed on Sep. 1, 2017, which is hereby incorporated by reference herein in its entirety.

What is claimed is:

1. An electronic apparatus, comprising:
a casing;
a monitor configured to be openable relative to the casing, the monitor including a display and a capacitance type touch detector which detects touch operation to a display surface of the display;
a signal generator configured to output a signal which indicates a position of the monitor relative to the casing; and
a memory and at least one processor which function as a control unit configured to:
control the display to a non-display state, when the signal output from the signal generator changes from an open signal, which indicates an open position in which the monitor is opened relative to the casing, to a close signal, which indicates a close position in which the monitor is closed relative to the casing so that the display surface faces the casing, and then a first period elapses without acquiring the open signal; and
implement control of disabling the touch operation to the display surface without waiting for the elapse of the first period, when the signal output from the signal generator changes from the open signal to the close signal.

2. The electronic apparatus according to claim 1, wherein in a case where the display is in non-display state and the touch operation is disabled, the control unit implements control of starting display of the display and enabling the touch operation to the display surface when the signal output from the signal generator changes from the close signal to the open signal and then a second period elapses without acquiring the close signal.

3. The electronic apparatus according to claim 2, wherein in a case where the display is in a display state and the touch operation is disabled, the control unit implements control of enabling the touch operation to the display surface without waiting for the elapse of the second period when the signal output from the signal generator changes from the close signal to the open signal.

4. The electronic apparatus according to claim 1, wherein
in a case where a first screen, in which functions corresponding to the start of touching can be executed, is displayed on the display surface, the control unit implements the control of disabling the touch operation to the display surface without waiting for the elapse of the first period when the signal output from the signal generator changes from the open signal to the close signal, and
in a case where a second screen, in which functions corresponding to the start of touching cannot be executed, is displayed on the display surface, the control unit implements the control of disabling the touch operation to the display surface when the signal output from the signal generator changes from the open signal to the close signal and then the first period elapses without acquiring the open signal.

5. The electronic apparatus according to claim 1, wherein the casing is formed of a material having conductivity.

6. The electronic apparatus according to claim 1, wherein the signal generator is a switch which outputs the open signal when the monitor is in the open position, and outputs the close signal when the monitor is in the close position.

7. The electronic apparatus according to claim 6, wherein the switch enters a pressed state when the monitor is in the open position, and enters a released state when the monitor is in the close position.

8. The electronic apparatus according to claim 1, wherein the electronic apparatus is an imaging apparatus having an imaging sensor.

9. The electronic apparatus according to claim 8, wherein the casing is a main unit having the imaging sensor.

10. A method of controlling an electronic apparatus having:
a casing;
a monitor configured to be openable relative to the casing, the monitor including a display and a capacitance type touch detector which detects touch operation to a display surface of the display; and
a signal generator configured to output a signal which indicates a position of the monitor relative to the casing,
the method comprising:
a step of acquiring a signal output from the signal generator;
a step of controlling the display to a non-display state, when the signal output from the signal generator changes from an open signal, which indicates an open position in which the monitor is opened relative to the casing, to a close signal, which indicates a close position in which the monitor is closed relative to the casing so that the display surface of the display faces the casing, and then a first period elapses without acquiring the open signal; and
a step of implementing control of disabling the touch operation to the display surface without waiting for the elapse of the first period, when the signal output from the signal generator changes from the open signal to the close signal.

11. A non-transitory computer readable storing medium recording a computer program for causing a computer to perform a method of controlling an electronic apparatus having:
a casing;
a monitor configured to be openable relative to the casing, the monitor including a display and a capacitance type touch detector which detects touch operation to a display surface of the display; and
a signal generator configured to output a signal which indicates a position of the monitor relative to the casing,
the method comprising:
a step of acquiring a signal output from the signal generator;
a step of controlling the display to a non-display state, when the signal output from the signal generator changes from an open signal, which indicates an open position in which the monitor is opened relative to the casing, to a close signal, which indicates a close position in which the monitor is closed relative to the casing so that the display surface of the display faces the casing, and then a first period elapses without acquiring the open signal; and
a step of implementing control of disabling the touch operation to the display surface without waiting for the elapse of the first period, when the signal output from the signal generator changes from the open signal to the close signal.
